(19) United States
(12) Patent Application Publication
(10) Pub. No.: US 2025/0245744 A1
(43) Pub. Date: Jul. 31, 2025

(54) COMPUTING PLATFORM AND METHODOLOGY FOR NETWORK-BASED MULTI-PARTY COMPETITIONS ASSOCIATED WITH CRYPTOCURRENCY TRADING ACTIVITIES

(71) Applicant: CFL Technologies, Inc., North Hills, NY (US)

(72) Inventor: Jason Kaufman, New York, NY (US)

(21) Appl. No.: 19/041,138

(22) Filed: Jan. 30, 2025

Related U.S. Application Data
(60) Provisional application No. 63/626,561, filed on Jan. 30, 2024.

(51) Int. Cl. G06Q 40/04; G06F 9/451

(52) U.S. Cl. CPC G06Q 40/04; G06F 9/451; G06Q 2220/00

(57) ABSTRACT

The present invention provides a computing platform and computing methodology for network-based multi-party competitions associated with cryptocurrency trading activities or other transactional system activities and using provable data sources to power gamified competitions, including network-based processing device(s) and UI functions. The method includes engaging with a first user for determining virtual funds and accessing a database having simulated tradable assets stored therein, as well as pricing information. The method includes engaging in a competition including calculating a buy-in cost for the first user based at least on the selection commands and the pricing information associated with the simulated tradable assets. The method includes presenting tutorials regarding simulated tradable assets. Upon completion of the defined time period, the method includes generating an output display including a final change in value of the virtual simulated tradable assets and any changes in the virtual funds.

### RELATED APPLICATIONS

The present application relates to and claims priority to U.S. Provisional Patent Application Ser. No. 63/626,561 filed Jan. 30, 2024.

### FIELD OF THE INVENTION

The invention relates generally to a network-based computing platform and executable software for conducting online network-based competitions simulating cryptocurrency trading activities or other transactional system activities and using provable data sources to power gamified competitions.

### BACKGROUND

For many individuals, there is a high barrier to entry when seeking to trade or otherwise learn more about cryptocurrencies. Thus, the form of wealth building and commercial transactions remains outside the reach of many users.

There are well established technologies for online stock trading activities, whether they be designated for short-term trading strategies, aka day-trading, or long term trading strategies. These technologies include known charting techniques for tracking, reporting, estimating, and otherwise interacting with data for making trading decisions.

Similarly, there are well-established technologies for simulating games or fantasy events. For example, there are well established technologies for virtually following a sports team or athletes, e.g. a fantasy football league. On these platforms, multiple users can compete with each other over various time intervals, competing based on estimations of third-party actions. For example, a competition can be over the length of a particular seasons, or a week, or even for a defined game.

There has also been a growth in online competition software technologies associated with the third-party events. These include mobile applications or computer software applications allowing individuals to place wagers, using real or virtual assets. While some software can include games of chance, there is also software for games of skill. Problems arise for games of skill where the users lack the foundational knowledge or education to effectively compete.

There is also the continued growth of different virtual assets available for public trading. A common example is a cryptocurrency. These virtual assets can include a higher learning curve to understanding the assets themselves, their values, how they are traded, how they are tracked, and the infrastructure associated with online transactions. Because this higher learning curve, there is a greater threshold for individual comfort in buying and trading these assets, thus excluding a large class of investors or potential investors.

Of the above technologies, none of them integrate gamification of trading activities, as well curing the educational deficit associated with the virtual currencies. Thus, there is a need for a method and system to better educate and demystify cryptocurrency trading and related online platforms and to gamify provable data sources.

### BRIEF DESCRIPTION

The present invention provides a computing platform and computing methodology for network-based multi-party competitions associated with cryptocurrency trading activities or other transactional system activities and using provable data sources to power gamified competitions. The platform provides for both education and competitions providing games of skill.

The invention includes a network-based processing device in operative communication with a plurality of local-processing devices, including communications via user interface functions. The network-based processing device further communicates with external data sources for acquiring cryptocurrency information.

The computerized method for generating simulated asset trading and gamification operations includes engaging with a first user for determining a first wallet of virtual funds available to the first user and accessing at least one database having simulated tradable assets stored therein. The method further includes accessing at least one third-party pricing database having pricing information associated with the simulated tradable assets and receiving selection commands from the first user for selecting at least one of the simulated tradable assets.

The computerized method further includes engaging in a competition of managing a cost of the simulated tradable assets over a defined time period. The competition includes calculating a buy-in cost for the first user based at least on the selection commands and the pricing information associated with the simulated tradable assets, electronically deducting the buy-in cost from the first virtual funds, and over the defined time period, further accessing the at least one third-party pricing database and updating the pricing information associated with the simulated tradable assets. The competition includes, upon further updating the pricing information, generate a costs status for the first user based on the pricing information and an ownership volume of the simulated tradable assets.

The computerized method includes presenting, via an output display, an option for viewing at least one of a plurality of tutorials for the first user regarding simulated tradable assets, the tutorials including information regarding pricing and related information on the simulated tradable assets, as well as adjusting the buy-in cost accounting for simulated tradable asset infrastructure costs. In the computerized method, upon completion of the defined time period, generating an output display including a final change in value of the virtual simulated tradable assets and any changes in the virtual funds.

In the computerized method, the simulated tradable asset can include one or more cryptocurrencies. In further embodiments, the simulated tradable assets can include a stock, a bond, a coin affiliated with a cryptocurrency, a coin unaffiliated with a cryptocurrency, property index, commodity item, or any other suitable item, fungible or non-fungible where the value of the item can be tracked over varying time periods.

As a common prior art failing is the mystification of trading various assets, the method further includes presenting, via the output display, at least one of a plurality of tutorials for the first user regarding electronic infrastructure associated with the simulated tradable assets. The electronic infrastructure associated with the simulated tradable asset includes at least one of: an electronic wallet and a blockchain data recording operation. Moreover, for cryptocurrencies, the pricing information can include a gas fee.

As part of the gamification of the learning process, the method may further include engaging with a plurality of other users and via user interface operations receiving input commands for the plurality of other users to select a plurality of simulated tradable assets and via a gaming processing engine, electronically track the plurality of users versus the first user during the defined time period. Therein, based on the gaming computing device and tracking the first user and other users profit values, upon completion of the defined time period, generating at least one tutorial for display to the first user regarding how to improve the first user's profit value during the defined time period. The defined time period is at least one of: a predetermined time period selected from a set of time periods and a time period determined by the first user.

The network-based processing device may be one or more servers or cloud-based processing systems, performing operations in response to executable instructions. The operations include data management and data manipulation via network and local processing operations, as well as accessing third-party data source(s).

The present invention includes an online platform/service where players can compete and wager against others (and themselves), using their skills in Crypto investing or other data sources such as stocks, music streams, or real estate sales/prices, without having to purchase/own any actual crypto currency or ownable assets/media associated with the data. In the example of using cryptocurrency as the data source, players do not need a crypto wallet or any special hardware, and they can play for free (to learn/practice) or place wagers/compete against others. The core (first) game gives each player an initial basis, such as $100,000 of virtual USD, and their goal is to virtually buy/sell (or short/exit) crypto currency (which stays in parity with the real prices), and end up with the most amount of virtual USD at the end of the game.

Players can play in any of the core system games (such as hourly, daily, weekly) (free or with wagers), and they can also host their own games (free or wagered).

The system gives players an even playing field where they can utilize their Crypto investing skills or data source knowledge to defeat other players (and to compare to their progress over time). Via user interface functions and network-based processing operations, the present invention provides a new platform for competition & wagering against friends and/or strangers online.

Education facilitates the skill competition. The system gives people a place to learn Crypto investing or other data-based knowledge such as stock investing, real estate investing, music/media consumption habit predictions, with no-risk, and to see their progress over time as they improve their skills. As in the non-limited case of cryptocurrency, it's virtual crypto/money, there is no need for a crypto wallet and all the risks, headache, and stress that comes with it.

In further embodiments, the system gives people the opportunity to host their own games, of which they can choose the rules such as max players, game start/end times, cost to enter (free/$$), winner prize pool distribution (if there is a wager). Hosts get a unique invite code to allow other players to join. Hosts can also earn money by being a ‘SuperHost’-they pay an extra fee but then earn a percentage of the total wagered amount (ex 2%).

The system can provide an onboarding experience for new-to-crypto people or new to the data source knowledge and associations and pattern based assumptions, allowing them to learn risk free as well as be directed to various services & physical items that they will need if/when they decide to start doing a ‘real’ financially based version like ‘real’ crypto investing on the blockchain (such as hardware/software wallets, crypto tax services, crypto exchanges, etc) or other financial transactions. In varying embodiments, users, third-party providers, and/or the processing system may earn commissions from directing users to these offerings.

Additionally, the computing system utilizes a virtual transaction system, such as a ‘virtual blockchain’ system that replicates the ‘transaction’ process for users. This allows users to get familiar with the concepts associated with the real-world counterpoints, such as in the case of Cryptocurrency, the concept of a ‘request’ (along with estimated prices/results), which is pending for a period of time and is then ‘accepted’ and processed (at the current live price of the crypto-currency or item(s) they have selected). The user sees the states of the transaction and is updated with the status & results.

In one embodiment, the system can include a Gas fee, which charges players a small financial amount during a transaction. The fees are subtracted from their main account (aka real money), not their virtual game wallet. The Gas Fee may be determined by how many players are requesting a transaction. The virtual blockchain, virtual transaction, and gas fee are all mimicking the real world interactions a user will go through if/when they do eventually start trading ‘real’ crypto or other related financial transactions, therefore teaching them important skills/info.

In one embodiment, the platform includes various processing elements, including functional operations performed by executable instructions run on one or more processing devices.

A front end: website/app/online service includes user signup, login, home (view/join available games/upcoming games), host a game, main game (board w/game functionality, such as buy/sell functionality, leaderboard), ‘default portfolio’ (the cryptos or other game play elements linked to the data sources that will be virtually purchased for the player at the start of each game), user profile, in-game Coins (buy/cashout), as well as other information/supplemental pages

One or more APIs provide for computing interactions. All front end (and admin) actions can go through the API to interact with the backend

On the network-side, the backend includes core logic that the API interacts with/that maintains the system/info.

The gaming engine is the core logic the runs the game play.

Database(s) holds the current states, game play, users, etc.

Administrative functions and operations allow for the system to view/manage users, games, system data, financial data, usage data, etc.

### BRIEF DESCRIPTION OF THE DRAWING

The invention will be described with respect to the following drawing figures, in which like numerals represent like features throughout the description, and in which:

FIG. 1 is a schematic diagram of a processing system;

FIG. 2 is an embodiment of a local processing device;

FIG. 3 is an embodiment of a network processing system;

FIG. 4 illustrates a flowchart of the steps of one embodiment;

FIGS. 5-8 illustrate sample screenshots;

FIG. 9 illustrates a flowchart of the steps of one embodiment; and

FIGS. 10-13 illustrate sample screenshots.

### DETAILED DESCRIPTION

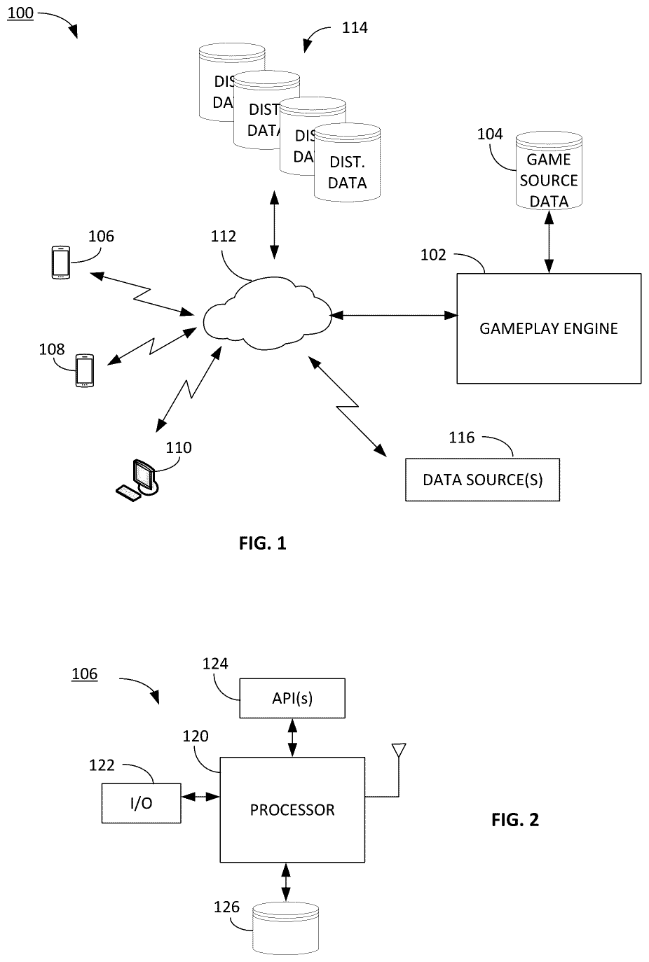

FIG. 1 is a schematic diagram of a system 100 for one embodiment of the present method and computing system. This system 100 includes a computing engine 102 disposed in a network processing environment, accessing data from at least one database 104. The system 100 further includes a plurality of local processing devices, such as a smartphone 106, a tablet computer 108, and/or a personal computing device 110. The user devices engage and communicate with the engine 102 across a network 112, such as the Internet or any other suitable network.

The system 100 further includes distributed data networks 114 providing the infrastructure for tradable assets, for example blockchain database(s) for recording cryptocurrency exchanges. This system 100 further includes pricing or other game-play data source(s) 116 also accessible via the network 112.

The engine 102 may be one or more network-based processing environments performing processing operations as described herein. The engine 102 can include executables run in a single processing system or can include distributed computing functions, such as available in cloud-based computing environments. The engine 102 executes processing operations in response to executable instructions, providing for functionality and data management as described herein.

The cryptocurrency or other game play source data 104 can be stored in a central or distributed memory structure. This data 104 can include account information usable for the functionality and data management described herein. For example, the data 104 can include portfolio information for various users and user accounts, the portfolios made up of fantasy-based ownership of available cryptocurrencies or other game play data such as stocks, music consumption, real estate sales/values, etc.

As used herein, the source data 104 can include simulated tradable assets. These simulated tradable assets are data field(s) representing or corresponding to available assets available for tracking, trading, monitoring, or otherwise using in a gaming or simulated trading environment. This data 104 represents simulated tradable assets, a representation of an asset but not the actual asset itself. This data 104 is simulated tradable as described in greater detail below, users can simulate trading these assets without incurring costs or uncertainties with acquiring actual versions of the assets. For example, one tradable simulated asset may be a representation of Bitcoin, a known digital cryptocurrency. This data 104 can represent ownership of Bitcoin, simulating ownership, instead of actual ownership.

The mobile or local processing devices 106, 108, and/or 110 can be any suitable processing device capable of executing instructions for performing functions noted herein. The devices include local operating system software, where functionality for the user interactions can be facilitated with application program interfaces (APIs) or any other suitable executable code for example but not limited to an executable software application or a browser-based executable.

The distributed data network 114 can be any suitable blockchain or other network for distributed data storage. The network 114 can include known existing distributed data network executables and authentication operations as recognized by a skilled artisan, the network 114 operating according to normal operations. In another embodiment, the data network 114 may not be an actual blockchain, but can be a memory structure simulating or emulating a blockchain or other financial/transactional systems/services.

The price or data sources 116 can be any suitable source such as sources for cryptocurrency values or other non-subjective, provable data. The sources 116 can include the crypto exchanges or ‘real’ registry for the assets themselves, can include any available public listing site, or any other source allowing for authenticated or reliable pricing or statistical information usable by the engine 102.

FIG. 2 illustrates one embodiment of the local or user processing device 106. The device 106 includes a processor 120, input/output interfacing 122, API(s) 124, and memory 126. The processor further includes communication functionality, such as the antenna, for wireless communication.

Consistent with known local processing devices, an end user interacts with the processor 120 via the modules 122. The processor 120 can execute operating system software, such as stored in the memory 126, and can additionally execute API(s) 124. The processor 120 further communicates across the network (112 of FIG. 1) for improved functionality.

The local device 106 is illustrated as a mobile phone or tablet computer. The present invention is not expressly limited to these embodiments, but rather the invention relates to the functionality made executable via the API(s) and the user interactions. The device 106 can be any suitable device for network-based communication and facilitating functionality as noted herein.

In one embodiment, functionality is browser-based. For example, the user accesses the server via a web browser, for example a Chrome browser. In this embodiment, the API(s) execute functionality with the browser executables, facilitating functionality as noted herein.

In another embodiment, the application may be a downloadable executable application (otherwise referred to as an “app”), such as being available from an app store or other central repository. In the embodiment of an app, the application runs locally on a mobile or personal computing device and performs functional operations noted herein via the application instead operations via browser-based executables.

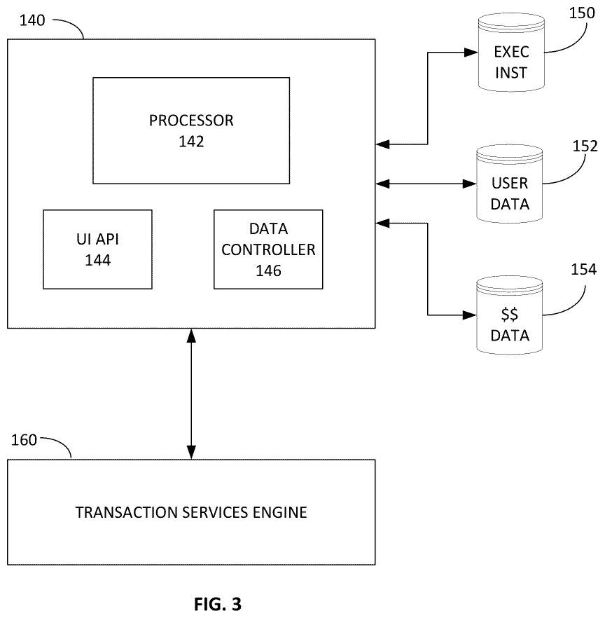

FIG. 3 illustrates one embodiment of a network-based processing device 140. The device 140 includes a processor 142, a user interface API 144, and a data controller 146. As recognized by a skilled artisan, the device 140 includes numerous additional processing and communication elements, omitted for brevity purposes only.

Moreover, the processing device 140 is illustrated as a single processing unit, but it is recognized the unit 140 can be in a distributed computing environment, including for example operating within a cloud-based computing environment using any number of processors.

The processing device 140 is in data communication with a first memory 150 storing executable instructions, a second memory 152 storing user data, and a third memory 154 storing financial or accounting data.

The processing device 140 further communicates with at least one financial services engine 160. This engine 160 may be a third-party commercial engine for conducting financial transactions, for example the payment processing platform operated by Stripe, Inc.

The user data can be any data relating to user accounting. The financial or accounting data can be data associated with cryptocurrency fantasy transactions or other data sources, as well as actual financial transactions for real monetary transactions. For example, the data controller 146 can include functionality for managing the user data, including operating both a virtual wallet holding virtual funds/assets and an actual wallet holding real funds/assets, such as US Dollars.

The processing device 140, via executable instructions, facilitates the cryptocurrency fantasy league (CFL) or the ‘anything’ fantasy league (AFL). In one embodiment, the CFL/AFL can be a free-to-play league and in another embodiment the CFL/AFL can be a fee-based event.

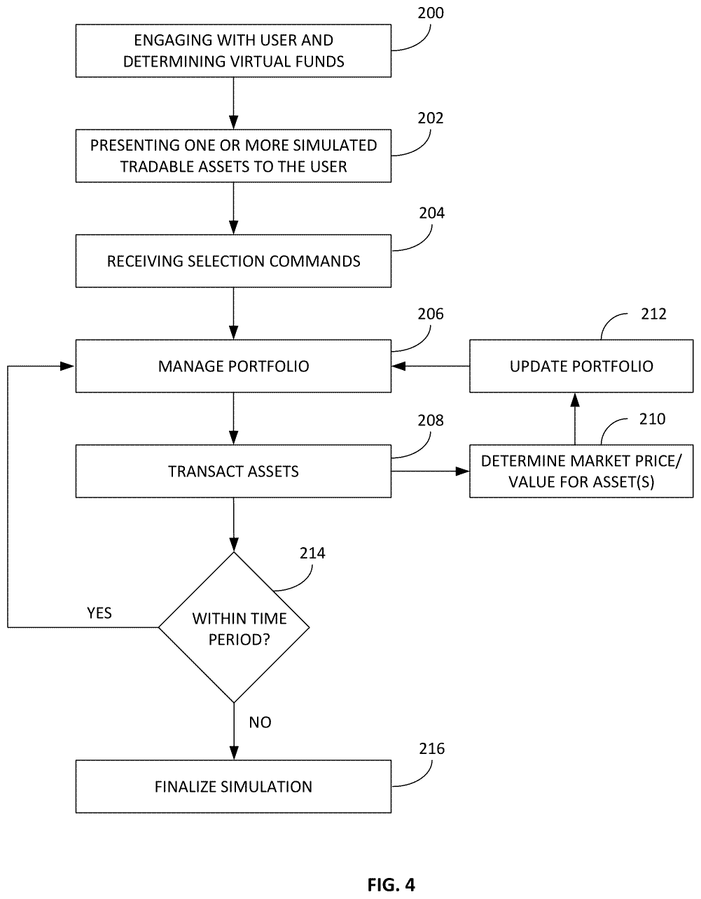

FIG. 4 illustrates a flowchart of the steps of one exemplary embodiment of a computerized method for generating simulated asset trading and gamification operations. The processing operations include functions for competing in games of skill, as well as receiving educational content. These processing steps can be performed on the processing systems of FIGS. 1-3 above. Step 200 is engaging with a user and determining virtual funds for an event. In one embodiment, the user engages his or her mobile device, e.g. device 106 of FIG. 1, to access the server. One embodiment includes accessing via login or security protocols, including potentially using credentials or authentication requirements.

For example, step 200 may include a user creating an account id and then logging into the server. In one embodiment, the creation of an account id may include associating financial information with the account. For example, a user may associate a credit card or other financial instrument for processing payments. In other embodiments, the user may have existing login credentials and merely verify access.

The user, upon logging into the server, can be presented with the platform's available events. One embodiment includes hosting or offering three primary events, an hourly event, a daily event, and a weekly event. These events are based on the amount of time available to play the game, such as by trading fantasy assets.

In one embodiment, a server-based control operation may include cut-offs or control functions to close or otherwise make active events unavailable for joining. Examples can include, but are not limited to, determining the event is partially completed, e.g. an hour event only has 15 minutes left, or determining the event has exceeded a number of entrants.

Herein, virtual funds can entirely virtual funds, virtual funds tied or referenced to physical funds, or entirely physical funds. For example, virtual funds can be points or simulated dollars available to the user. Virtual funds tied to or referenced to physical funds can be where the user purchases virtual funds using real currency, for example purchasing 10,000 virtual dollars for $100 US Dollars.

The determining of virtual funds in step 200 can include one or more varying options depending on the user's preferences, the gaming platform, or other factors. One option can be assigning the user a set amount of virtual funds upon registration, for example allowing a complete novice to use $10,000 virtual dollars to learn about cryptocurrencies and the process of trading, selling, etc. One option can be assigning the user a certain amount based on various factors such as number of competitions, status on the platform, number of other user referrals, etc. One option can be allowing the user to purchase virtual funds using a payment processing, including but not limited credit card transactions, trading cryptocurrencies or other assets, etc.

The user actively joins an event. The event, as used herein, is an online session occurring for a predefined time period where the user can engage in simulated transactions, including buying, selling, holding, shorting, simulated tradable assets. As part of the simulated events, the user can engage with tutorials on the various aspects of the transaction process.

As part of the event, the user receives a seed amount usable for game play actions, such as purchasing tradable assets, e.g. coins. Step 202 is presenting one or more simulated tradable assets to the user.

For example, one embodiment may include a seed amount of $100K, but any amount can be used. In another embodiment, the seed funds may be in any suitable format, including pre-allocation of game assets (such as crypto) or a combination of assets. Presenting in step 202 can include providing education as part of the selection process, as well as education on gathering information on the associated assets, for example learning about the history of a particular cryptocurrency coin, if the coin is tied to underlying assets, the market history, transaction costs, volatility, etc.

In step 204, the computer processing system receives selection commands, representing the user selecting simulated tradable assets to build an active portfolio. Where the event uses pre-determined simulated tradable assets, the receiving commands can include the user acknowledging the predetermined portfolio and/or allowing the user to supplement or modify the portfolio. These operations are performed via interactions with the user interface running on the local or client device and network-based operations performed at the server or cloud level.

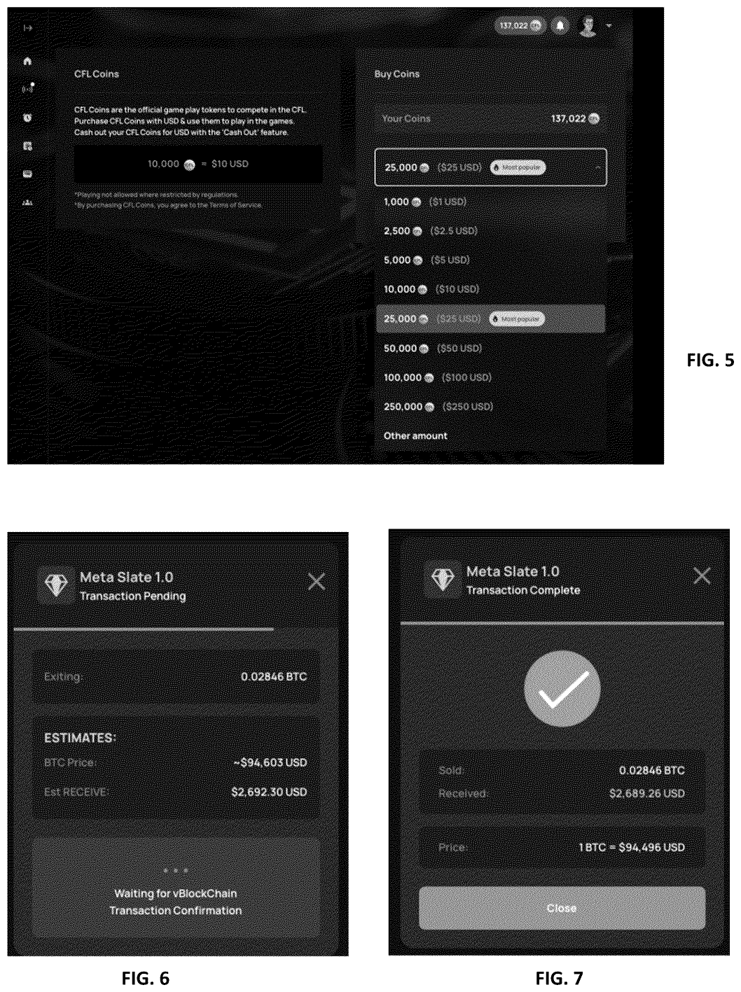

By way of example, FIG. 5 illustrates a sample screenshot of a user interface for User 1 buying coins operating as virtual assets available for gameplay. In this sample screen shot, the user can purchase coins at an exchange rate of $1 for 1000 virtual coins, but any suitable ratio, linear or graduated, may be used.

In another example, FIG. 6 illustrates a transaction interface for allowing the user to purchase a simulated tradable asset. Here, the asset is the BTC coin, noting an active price per coin, a proposed amount (including integer and/or non-integer values), and the corresponding virtual funds required to complete the transaction.

Upon completion of the virtual transaction, FIG. 7 illustrates the completed transaction.

Selection of cryptocurrencies in step 204 can include accessing market prices for asset(s), like step 210 below. In FIG. 1, the engine 102 acquires pricing information from price source(s) or data/stats information from data source(s) 116. These sources can be any suitable network-based data repository or accessible site or location having current pricing or game-play data/information. One example can be one or more crypto exchanges showing real-time price data.

In further embodiments, the gameplay interactions such as buying and selling of cryptocurrencies can include additional operations. As the CFL/AFL includes learning operations, the users can be presented with tutorials or other features helping navigate the complexities of trading operations and processing info into decisions to make game play transaction such buying/selling. For example, with cryptocurrency, the buying and selling further includes not just the financial transaction, but underlying infrastructure associated with crypto asset exchange. For example, a buy order can include generating a buy request presented to a market exchange seeking acceptance for a counterparty. For example, a buy order can include the processing specifics for settlement of a transaction, including wallet information exchange, data repository deposition to record the transaction, etc

Moreover, the buying and/or selling of game play assets such as cryptocurrency is not limited to just buying or selling or trading of assets. The users may seek to engage in a higher level of transactions, including learning about these transactions. Examples of transactions can include using put options, short selling, among other options.

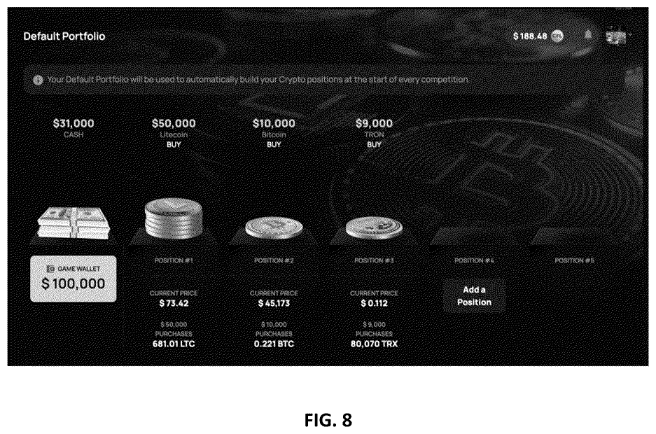

In further embodiments, competitions may include a default starting portfolio. In one embodiment, a default portfolio can be determined at a system or server level, whereby users are presented with a defined portfolio. In one embodiment, all users start with the same portfolio of assets. In another embodiment, users can answer questions or otherwise select a risk level and the starting portfolios can be selected based on the user's risk tolerance. FIG. 8 illustrates a sample screenshot of a default portfolio provided to the user, including a wallet and predetermined or suggested levels or allocations of different assets.

Step 206 is actively managing the portfolio. In the gamification of the exchange process, the operations of portfolio management can be for the predefined time period. For example, one time period may be one hour, where the time period can be any suitable period of time for the competition. Each user has their own portfolio and therefore selects which game play assets to purchase, which assets to sell or trade, and which assets to hold. During this event, the users can access additional market information to further learn more about the asset markets, potential trading trends and any other informative content.

For example, during the event, a user unfamiliar with how the data sources such as cryptocurrency exchanges operate can watch informative videos and read articles. Then, as the user manages the portfolio, even though operating in a fantasy scenario, the user becomes familiar with the data source/exchange process.

Varying embodiments can include education as a prerequisite for gameplay or part of the skill competition. For example, one embodiment may include pausing or restricting gameplay until the user reviews specific educational content, e.g. watching a video, reading an article, etc. In another embodiment, the user may be required to take a quiz or other form of interaction to verify both attention to educational content but also base minimum proficiency for the skill competition. Further embodiments may use access to educational content and/or testing or verifying knowledge as a gatekeeper for additional functions, levels, competitions, etc. In one example, if a user takes a quiz and achieves a passing score, the user can be presented with options for then performing additional trading activities. One example may be a tutorial about how to short or otherwise hedge a particular asset and those features are locked and unavailable to the user until the user passes a quiz or other proficiency test.

As part of the asset management, the user buys and/or sells/trades assets, step 208. Via the user interface, the user may select a specific asset to sell, as well as a selected amount. For example, the user wishes to purchase Ethereum, step 210 is to determine a market price for the asset. One embodiment can be accessing a market exchange and acquiring the market price, for example accessing Coinbase.com and retrieving the market price.

In one embodiment, asset transactions can be for a value amount, e.g. US dollars. Whereas in varying embodiments, asset transactions can be exchanging additional assets. For example, instead of selling a cryptocurrency assets for a dollar amount, the transaction can be a like-kind exchange, such as selling a first cryptocurrency for an equivalent or equal amount of a second cryptocurrency asset. In exchanging assets for assets, the users can identify or learn about reduction of gas fee charges.

In the event the user is seeking to purchase the asset, the user may require the market price prior to selecting a number of assets for purchase. For example, if the user has available fantasy funds of $100,000 and the current Ethereum price is $2500 per unit, the user can determine how much of their available funds they wish to spend.

From the user's perspective, step 212 is updating the portfolio. The engine performs additional operations, as noted in FIG. 6 below. Updating the portfolio includes updating the user display, e.g. FIG. 5, showing the portfolio and asset allocation. The method reverts back to step 206, the user actively managing the portfolio.

In step 214, a determination is made if the event is active. When the event is no longer active, e.g. the term of the event has expired, step 216 is to finalize the event. This step includes determining the market price for the asset(s) and calculating a final tally of the amount of money or game play value each user gained or lost during the term.

From there, the engine can then generate a final leaderboard showing an order of success for each player in managing his or her portfolio or playing the game. In one embodiment, finalizing the event can include distributing winnings to winner(s). For example, the financial services engine 160 can be used to distribute credit to the users. In another example, the winnings may be credit held within the engine itself usable for offset costs associated with fee-based competitions.

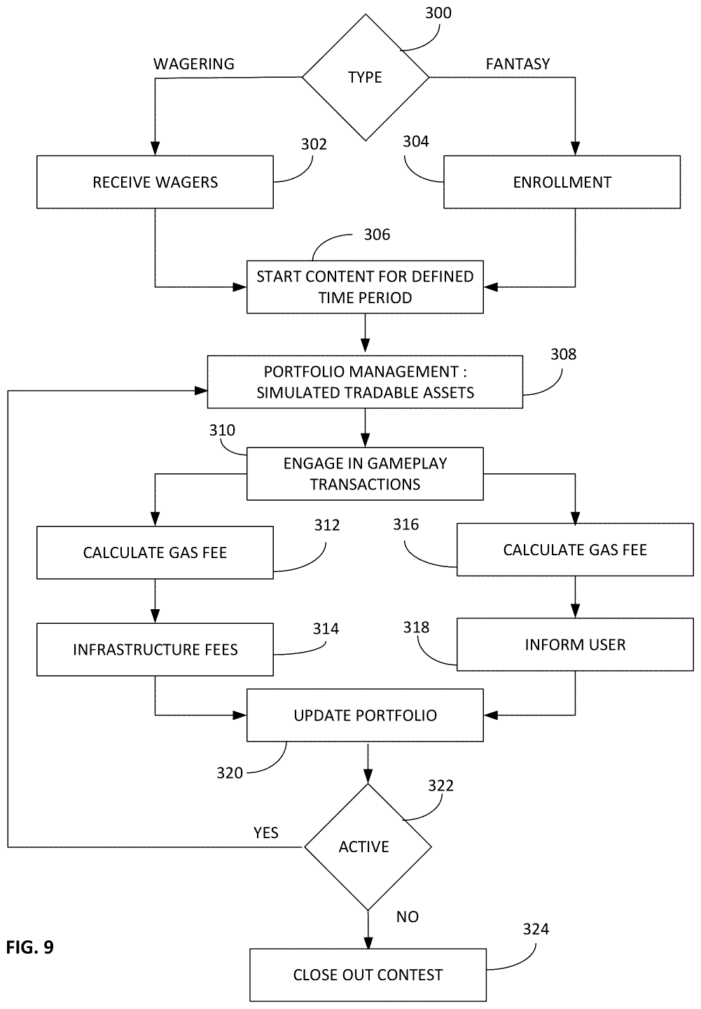

FIG. 9 illustrates processing steps associated with a single user or a single user as engaged with the platform. For example, the user may compete with computer engines, seeking to compare trading and asset management functions against these compute engines. The computerized method is further available for one or more additional users to engage in the competition, such that various users are competing with each other for maximizing asset trading and management functions.

The steps of FIG. 9 can include functionality performed by the engine 102 of FIG. 1, and/or operations performed by the processor 142 of FIG. 3. Herein, users engage the game data or cryptocurrency fantasy engine 102 via user interface controls across a network, such as the Internet. The interface can be web-based, operating within one or more browser windows. In another embodiment, the interface may be part of an executable application or API associated with another application.

Step 300 is determining which type of skill-based contest is being offered. In one embodiment, the there are 2 types: (a) wagering; and (b) informative. Both these contests can operate in similar or identical fashions, the former offering a chance for users to win money or other prizes engaging in a fantasy trading competition and the latter offering an educational experience for users without financial risks.

If the contest is wager-based, step 302 is establishing the contest and receiving wagers. As noted in FIG. 3, the processor 140 engages a financial services engine 160, therefore enrollment in step 302 may include accessing the engine for acquiring the buy-in, ante, or other required funds to enter the contest. Additional security and privacy requirements may be included when accessing financial services engines, including additional identity and/or account verification.

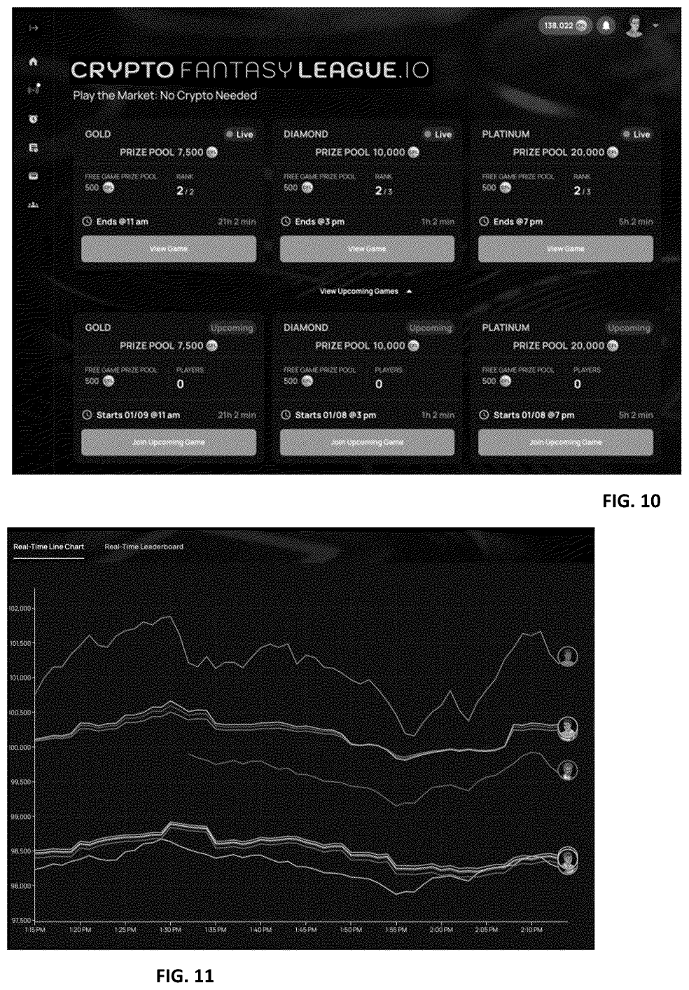

By way of example, FIG. 10 illustrates a screenshot of one embodiment allowing a user to view active games either in-progress or available for joining. These contests can be for real/tangible pay-ins and pay-outs, virtual pay-ins and pay-outs, and a combination of both. The user engaging the platform may select one of the games to enroll, thus purchasing coins, e.g. FIG. 5, and/or building a portfolio, e.g. FIG. 8.

Further embodiments provide for enhanced wagering options, including hosting and setting various league or contest rules. For example, contest hosting can be general to the platform and/or individual users can host their contests. Where users host contests, the hosting user can generate fees (virtual and/or real) for in-game transactions, using entries, and other fees. In further embodiments, the platform or executable software can include dynamic wagering information for users seeking to enter contests. For example, prior to joining a contest users can see how much there is available to win in each wager level, and when the user joins the contest this can then dynamically update the available purse.

If the contest is a free or non-wagered fantasy event, step 304 is acquiring enrollment. Similar to FIG. 4, the enrollment can include users selecting a particular event, such as an hourly event, a daily event, a weekly event, etc. Enrollment includes users selecting an enrollment button or other UI feature.

On the back-end, the processor 142 can collect or otherwise electronically assemble account information for users enrolled in either type of contest. Step 306 is starting the contest for the defined time period. For example, if the contest is an hourly contest running from 13:00-13:59:59 EST, the contest can be officially started at 13:00 EST. Starting the contest can include any number of suitable opening or engaging techniques, for example notifying the user the contest is open or making the portfolio management/selection interface available or otherwise “live” only once the contest time period begins.

In addition to time-based competitions, the platform may include varying levels of required interactions in different skill-based competitions. For example, competitions may require the user to hold multiple assets and engage in multiple types of transactions over the course of the event. These competitions educate the user on trading transactions by requiring multiple transactions as part of the competition.

Step 308 is portfolio management operations. These include users adjusting their game positions such as their crypto portfolio by buying and/or selling cryptocurrency or other assets. Portfolio management 308 may further include market research or other educational activities. The fantasy trading engine emulates real-world asset portfolio management such as for crypto, therefore educating the user on the market, the trends, and related factors is part of the overall fantasy experience.

Once a user decides to adjust his or her portfolio, step 310 is engaging in a buy transaction and/or a sell transaction. The user may engage in numerous buy transactions to build out an initial portfolio. Similarly, a user may hold off acquiring any assets, for example estimating the overall market is going to decline and the user seeks to time the transactions to “buy the dip.”

In another embodiment, a contest or event can include presenting the user with a preset portfolio of assets instead of funds. For example instead of starting with a virtual wallet, each user is presented with a start portfolio of pre-selected assets.

In the wagering system, step 312 is calculating a gas fee. For example, for crypto, as part of the learning on trading cryptocurrencies, the user can be informed of gas fees associated with various transactions. As recognized by a skilled artisan, a gas fee is an amount of money or other fee paid for conducting a transaction on the underlying cryptocurrency network. Thus, while the contests are fantasy-based, inclusion of a gas fee further simulates the reality of the portfolio management.

Step 314 is acquiring an actual processing fee from the user in relation to the gas fee of step 312. For a wagering contest, one embodiment includes users paying the actual gas fee using real world funds, such as accessed through the financial services engine 160 of FIG. 3. Here, the processing system may treat the game play transactions, such as buying/selling/trading differently based on the contest being a wagering or informative contest. For example, the transactions can include time delays associated with transactions, infrastructure costs associated with transactions, among other factors. Infrastructure costs can include fees associated with virtual wallet(s), recordation of transactions, and other infrastructure elements associated with decentralized and virtual assets.

These fees can be paid each time a transaction occurs, or in another embodiment a user's account can hold a balance and the fees deducted from the account balance, to minimize transaction fees with the financial services engine.

For the informative contests engaging in game play transactions, such as buying/selling/trading, step 316 also includes calculating the gas fee. Here, this fee calculation may be identical to step 312, but can also include different steps. For example, one embodiment may include not only generating the fee, but generating a display or other interface for informing the user of the fee and how the fee is calculated, step 318. Here, the user can learn about how gas fees affect the management of a portfolio. One embodiment can include deducting the gas fee not from any real-world financial account, but instead deducting the gas fee from the user's portfolio.

In one embodiment, with starting a content whether using a default portfolio or a user-generated/user-selected portfolio, the system may purchase the assets as part of the game set-up and then adjust or lower the gas fee.

Step 320 is to update the portfolio based on the hypothetical or fantasy-based transaction. Where a gas fee costs actual money, the updated portfolio can be updated solely to reflect the change in values, e.g. new portfolio balance based on the purchase or sale of an asset.

In another embodiment of step 320, updating the portfolio can further include recording or otherwise documenting the financial transaction. For example, where a real-world crypto or other exchange function is documented via a distributed data ledger (e.g. Blockchain), the present method and system can simulate or otherwise perform a similar function.

As noted above in FIG. 1, the distributed data ledger 114 represents a type of blockchain or similar facsimile thereof. Here, the engine can then generate the blockchain entry on the ledger documenting the transaction. As the engine seeks to educate users on game play actions such as cryptocurrency transactions and real-world operations, the blockchain ledger entries further simulate real-world crypto transactions.

Step 322 is a decision step if the time period is still active. If active, the method continues back to step 308 further users engaging in portfolio management activities. If the time has expired, step 324 is to close out the contest. If the contest is a wagering contest, the results can include distributing winnings to various users based on preset or dynamic rules such as ‘winner takes all’, ‘top 5’, ‘top 10%’, etc.

Concurrent with the operations for the first user, the present computerized method performs similar operations for any number of users. See, e.g. FIG. 1 with sample multiple users 106, 108, 110. Any suitable number of users may engage the engine 102 (FIG. 1) for competing in one or more competitions, also buying, selling, holding, shorting, or otherwise transacting with simulated tradable assets.

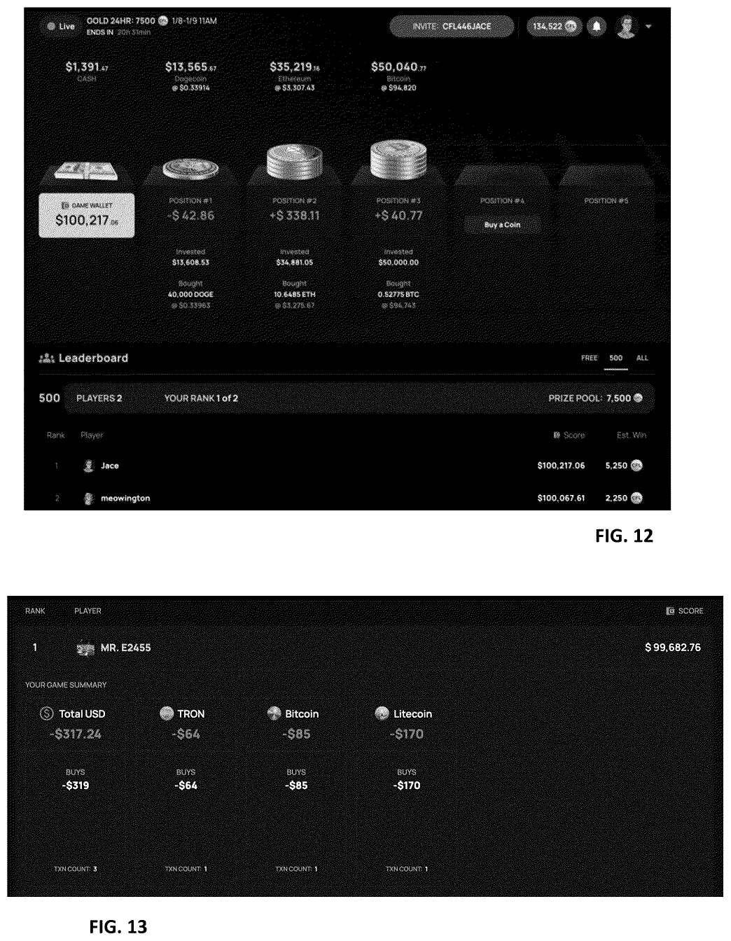

For example, during the predefined time period, user interfacing functions can provide for comparing or tracking competitors. FIG. 11 illustrates a sample graphical output showing multiple users can the changes in values of their portfolios during the course of the event. FIG. 12 provides another sample screenshot of the user's portfolio/holdings and a leaderboard. In this example, the user can view not only the status of their portfolio, but also their standing in the competition. FIG. 13 illustrates a sample screenshot of a post-event recap of the user's actions during the event.

As the present computerized method includes demystifying the trading process, educational features can include videos, articles, and/or other content analyzing the user's interactions during the event and providing additional feedback. For example, if the user failed to diversify holdings, the user can be presented with an article or video on the benefits of diversification. For example, if the user failed to detect a trading trend for a simulated tradable asset, the interactions can include information on trend analysis. For example, if the user incurred a lot of infrastructure or trading costs, information can be provided on the additional costs associated with trading various digital assets.

The educational operations can be based on predetermined analysis of the user's activities, e.g. if many transactions are noted, the user can be automatically presented information on associated transaction costs. In one embodiment, an interaction history can be provided to a machine-learning or other artificial intelligence engine that can perform a data analysis to assess and ascertain weaknesses in the user's gaming strategy and provide or recommend appropriate educational content.

The present method and computing system can include any number of varying embodiments both for improving user learning operations, as well as facilitating fantasy-based competitions.

In one embodiment, the platform can help transition a user from fantasy-based transactions into real world transactions. For example, the platform can include recommendations and/or data exchange with real world trading platforms/partners. These examples can include any or all features for real-world crypto exchanges, including crypto wallet(s), security functions, preferred markets or exchanges, etc. In one embodiment, the platform may include receipt of a referral fee or other monetary incentive for introducing the user to commercial partners.

In one embodiment, users can set-up and run leagues or their own competitions. Incentives for the user can include capturing real world funds as part of the game play transactions, such as buying/selling/trading occurring during the event. For example, for wagering events the platform can calculate and charge a gas fee, with some or all of the gas fee being paid to the league host. For example, the platform can charge a vigorish for using the platform for wagering activities, with at least a portion going to the host. Other financial embodiments can be utilized, for example hosting a sponsored event with a percentage of the purse allocated to the host.

As part of the educational features, competitions may include requirements for the user during the defined time period. Performance of these features can include receipt of bonus elements and/or unlock additional competitions. For example, one event may include a requirement the user engage in at least 3 separate transactions for buying and/or selling simulated tradable assets. For example, one event may include the user to perform shorting operations or by swaps or other instruments. The computerized method can unlock higher levels of options for users upon showing use or proficiencies of trading strategies.

In one embodiment, a host or a “super-host” can include users engaging in alternative fee structures or financial arrangements. These arrangements can include combinations of virtual wallet amounts and physical wallet amounts. In one embodiment, the host or super-host can include matching or spotting wagering funds for users and seek to recapture with transaction fees.

The platform can further include not only active game information, but also historical information. Users can be ranked or otherwise rated not only for specific contests, but also over longer periods. Leaderboards can indicate all time high scores as well as other data ranking overs.

In further embodiments, users or the platform can set specific rules for competitions. For example, if the objective is to learn basic crypto asset transactions, the contest rules can limit transactions to buy/sell. For example, if the object is to learn short selling transactions, the contest rules can limit transactions to short selling activities. In another example, if the object is to learn to identify potential hit songs in a certain genre, the contest rules can limit game play to just songs in that genre.

In one embodiment, the platform operates using coins, referred to, as an example, as CFL coins or AFL coins. These coins have no tradable market value but are in-game currencies. The use of coins as in-game or in-content currency further assists the user in learning about the data source, such as cryptocurrencies. In one embodiment, these coins can be cashed out via the financial services engine, for example if the user purchases coins for engaging in a wagering event or wins coins for an non-wager/informative event. The platform includes, among other features:

Front end: website/online service/app-user signup, login, home (view/join available games/upcoming games), host a game, main game (board w/game play functionality such as buying, selling, trading and a leaderboard (filterable for the various available wager levels)), ‘default portfolio’ (the game play assets such as cryptos that will be purchased for the player at the start of each game), user profile, CFL/AFL Coins (buy/cashout), and supplemental pages.

The method and system can include additional or advanced trading options. For example, players may perform actions like setting buy/sell limits or other rule-based trading functions. The inclusion of trading rules allows for accurate simulation of actual trading operations, as well as allowing users who use these next-level trading options to improve their ability to win the various contests.

The method and system can include numerous techniques for monetizing and rewarding the gamification operations. For example, as noted above, embodiments for players can include superhost operations, winning wagered games, winning free pool events/games, as well as referral fees or bonuses for bringing on new entrants. Exemplary embodiments of revenue generation for the system can include: (a) fees for joining a game including entrance fee and/or “vig” for wagers; (b) fees from the wager pool for example a set fee or a percentage amount; (c) fees for hosting a game payable by the host or individual entrants; (d) fees for being a SuperHost such as a set fee or multiple of the wager (e.g. 2× the wager); (e) gas fee(s) for game play actions, for example gas fees being calculated and paid with in-game credit for learning events and gas fees being calculated and paid via financial transactions using real financial money or in-game credit redeemable via a commercial transaction; (f) subscription fees can be added allowing users to subscribe and access additional learning information or financial resources, access to locked or member-only games and features, allowed to wager at a set level, reduced gas fees or other costs, etc.; (g) special features within the platform for example hiding a persons identity or benefits; (h) cash out fees can be paid such as a set amount or percentage of money cashed out, for example commensurate with 3rd party financial transactions; (i) affiliate fees associated with connecting players with third-party service provides via the platform; and (j) other gameplay assets or benefits as recognized by a skilled artisan.

API: all front end (and admin) actions go through the API to interact with the backend.

Backend: the core logic that the API interacts with/that maintains the system/info.

Engine: the core logic the runs the game play.

Database(s): holds the current states, game play, users, etc.

Admin: system to view/manage users, games, system data, etc.

The CFL/AFL provides people a new way to compete & wager. The

CFL/AFL enables people to learn & compete with data source related skills such as Crypto investing skills in a risk-free environment. The CFL/AFL gives people the ability to use their data source related skills such as Crypto investing skills to compete against overs in a fair way that removes the variables of their real-world financial situation (amount of money available, risk tolerance, etc). The CFL/AFL gives people the ability to host their own games (and set the rules), and compete against players of their choice. The CFL/AFL gives people the ability to earn money from hosting games (even if they don't win themselves). The CFL/AFL provides a natural onboarding experience for new crypto users into ‘real’ crypto services, and provides routes into the available services they may need in their journey.

The platform further provides for ways to ‘compete’ with data source based skills, such as crypto investing based skills. An example includes enabling players to bet that they will earn a selected % of value in a set amount of time (ex: Earn 5% in 24 hours to win: $50 bet earns you $75). Other iterations could be ‘first to 100%’, where the winner would be determined by whoever doubles their money (either with no timeframe or with a timeframe). Other iterations allow users to connect a real data source based financial account, such as a real bank account or crypto wallet.

During game play there may be a subset of available assets for a user to select, for example, there could be a subset of Crypto Coins available for the user to select. Future iterations could include ‘brackets/leagues’, for example, for crypto they could include ‘Shit Coins’, ‘Top 10’, ‘On Binance’, or ‘All’ (which would allow the user to select any crypto currency that's trackable/vetted). Further embodiments can include adding additional coins or other assets (e.g. NFTs) as they are trackable and tradable with a fixed market price.

Varying embodiments allow players to team up and play against other teams. In this case, as an example, a team of 10 may be given $100k each ($1M total), and at the end of the game, the team that collectively has the most money wins. As in all games, wagers could be placed on the game.

One embodiment includes a ‘march madness’ /elimination/tournament style competitions where users (or teams) would compete against another player/team (or group of players/teams), and the winners advance to the next level. Wagering can be performed on teams or other features, including for example side-bets or ancillary wages. For example, instead of betting on a particular user, a side-bet can be a wager that a certain number of a particular type of asset such as a coin will be traded within the first 15 minutes of a contest, etc.

The method and system can include additional embodiments for trading activities. For example, when not enough players have joined a game (aka a minimum players threshold was not met), the system can auto-adjust the game/entries. This can function differently depending on the type of game. In one example, for Hosted Games: If only 1 player is entered at the start of the game, the start time of the game can be pushed back (ex: 24 hrs later). In another embodiment, for Core Games: For each wager level, wagers can be moved to a next competition (of these same type/timeframe) if no one joins that wager (either by end or threshold/window to join live game). Players can be alerted of the adjustment via system announcements and other messaging services such as email or text message.

In another embodiment, the free play games can include a free play pool. For each core game, all players (free and wager) automatically play against each other for the ‘Free Play Pool’ (FPP). In one embodiment, a percentage from all wagers on the game goes to the FPP (ex 2%). For example, if 10 people wager $1 and 2 people wager $20, there will be a total of $50 wagered at 2%, there would be a FPP of $1 distributed to winners of the full group's game. The FPP can also include other sources of money, value, rewards, or other remuneration, such as from ‘new players bonuses’, gas fees, system specials, sponsors, etc.

In another embodiment, at the end of a game there are a few ways for players to review their actions/performance. In one embodiment it can include a Game Summary: for the player to review of all the assets they owned during the game and how they performed. Another embodiment includes total USD & Assets they owned: net profit loss, net from buys, net from shorts, net from game play action, transaction count. In one iteration, players can see other players game summary only after the game ends. In another iteration they can never see other player's game summaries. In another iteration, players can pay a fee (CFL/AFL coins) to hide their game summary. In one embodiment, the system can generate an Ending Portfolio: summary of the end state of their portfolio (final USD value, asset amount/values).

In addition to a player reviewing their actions/performances, the method and system may additionally track and display player activities/performances across any suitable time span, including days, weeks, months, etc. One embodiment of gameplay data can include a display of a player's account balance(s) over the time period. Another other suitable embodiment of gameplay data may be used, as recognized by a skilled artisan. One display embodiment can include using graphical displays, such as a line graph any other suitable display, including optionally using varying colors or other identifiers. Further embodiments may include selecting one or more specific players to be graphically displayed in relation to each other over a time period, such as displaying the results of the top five, top ten, etc., players over a time period. Other display variations including selecting or designating players to view, for example socially-connected players or players otherwise connected.

Depending on the game play and data sources used, there may be some processing done by the system, using defined rules, to translate the data into a ‘system point value’, which can be used to score and rank players game play choices/game asset portfolio. In the case of the CFL's example crypto game, the player's total USD is used ‘1 to 1’ as the user's points (aka $100,000=100,000 points). The amount of game play ‘slots’ available for the user can also vary (based on game rules/situations).

The game play, data sources, and point calculations may be different in other iterations.

Card Play Style. For example, a player may get access to cards which each have a crypto currency (or other asset) on them, and they would choose which cards to play in their available slots (and potentially if they wanted other play settings such as the purchase being a ‘buy’ or ‘sell’ or setting rules based actions like stop/limit orders. Each slot could have a different multiplier on it, which could further affect the resulting points a player will earn based on their choices. While a card is played, the user could earn (or lose) points based on how the crypto (or asset) performs. In this iteration, the final points earned/lost could be determined by how the crypto (or asset) performed while in play, multiplied by the slot multiplier.

Variations on point calculation rules could include: applying the multiplier to only gains; and using the ‘buy’ /‘sell’ selection (for gain/loss of points) or always using ‘net change’ for point gain.

Other Data Sources: Music & Media (FML). In another iteration where we use music or media streaming numbers (from a data source with reliable numbers), we may define a stream as being worth 10 points. Players could have cards representing the various media/performers/creators, and they can choose if/where to ‘play’ their cards. The available slots can have multipliers as well, leading to more riding on the players choices during game play.

In one iteration focusing on music, there can be cards to represent songs, artists, and albums. A user playing a Song card would earn points for the streams that song generates while in play during game play (along with a potential multiplier/other bonuses). A user playing an Album card could earn points from all of the songs on the Album. A user playing an Artist card could earn points from all of the songs by the Artist. There could also be other special cards that could be used

In these iterations, the players scores & rankings would be processed/determined by the system by applying the game play/calculation rules to the data from the data source. In the example of music & streams, the cards played by each player during game play will each have potentially earned points while in play. Applying the multipliers & other bonuses in play, the system would be able to calculate the specific points earned for each user, and they apply a ranking based on their point levels.

Card Marketplace. In a simple iteration, game play cards can be given to players during the game (either randomly or preset card packs). In another iteration, the game play cards can be bought, won, earned, listed/sold, & traded. In this case, there would be a marketplace for players to do those functions & more. In addition to potentially winning money from the free play pool and wagers, Players can also earn game play cards. Players can also buy packs of cards from the marketplace.

The platform can additionally operate and allow trading operations in relation to non-fungible tokens (NFTs) or related assets. In the case of NFTs, the system may include game play calculation rules using various data from the blockchain, such as ‘floor price’, number of sales, number of owners, rarity, etc. In one iteration, game play cards representing NFT collections and/or specific NFTs can be used by the player to try to earn the most points during game play. Points could be earned based on an algorithm utilizing various factors such as the performance of the collection (floor price gain/loss/net gain, number of sales, etc).

Depending on the type of game and assets, the method and system may include other ‘real-world’ counterparts involved in the transactions that are simulated within the platform. Some can be fee based (such as the concept of a ‘exchange fee’ for transaction) and could either be ‘taken’ from the user's game play ‘wallet’ (lowering their score) or from their system coins. Another example includes acting as an LP, allowing a player to put their game play USD to use by providing liquidity (virtually).

While the invention has been described with respect to certain embodiments, the description is intended to be exemplary, rather than limiting. Modifications and changes may be made within the scope of the invention.

Figures are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. As used herein, executable operations and executable instructions can be performed based on transmission to one or more processing devices via storage in a non-transitory computer readable medium.

What is claimed is:

1. A computerized method for generating simulated asset trading and gamification operations, the computerized method comprising:
engaging with a first user for determining a first wallet of virtual funds available to the first user;
accessing at least one database having simulated tradable assets stored therein;
accessing at least one third-party pricing database having pricing information associated with the simulated tradable assets;
receiving selection commands from the first user for selecting at least one of the simulated tradable assets;
engaging in a competition of managing a cost of the simulated tradable assets over a defined time period, including:
calculating a buy-in cost for the first user based at least on the selection commands and the pricing information associated with the simulated tradable assets;
electronically deducting the buy-in cost from the first virtual funds;
over the defined time period, further accessing the at least one third-party pricing database and updating the pricing information associated with the simulated tradable assets;
upon further updating the pricing information, generate a costs status for the first user based on the pricing information and an ownership volume of the simulated tradable assets;
presenting, via an output display, an option for viewing at least one of a plurality of tutorials for the first user regarding simulated tradable assets, the tutorials including information regarding pricing and related information on the simulated tradable assets;
adjusting the buy-in cost accounting for simulated tradable asset infrastructure costs; and
upon completion of the defined time period, generating an output display including a final change in value of the virtual simulated tradable assets and any changes in the virtual funds.

2. The method of claim 1, wherein the simulated tradable asset includes a cryptocurrency.

3. The method of claim 2 further comprising:
presenting, via the output display, at least one of a plurality of tutorials for the first user regarding electronic infrastructure associated with the simulated tradable assets.

4. The method of claim 3, wherein the electronic infrastructure associated with the simulated tradable asset includes at least one of: an electronic wallet and a blockchain data recording operation.

5. The method of claim 2, wherein the pricing information includes a gas fee.

6. The method of claim 1 further comprising:
engaging with a plurality of other users and via user interface operations receiving input commands for the plurality of other users to select a plurality of simulated tradable assets; and
via a gaming processing engine, electronically track the plurality of users versus the first user during the defined time period.

7. The method of claim 6 further comprising:
based on the gaming computing device and tracking the first user and other users profit values, upon completion of the defined time period, generating at least one tutorial for display to the first user regarding how to improve the first user's profit value during the defined time period.

8. The method of claim 1, wherein the defined time period is at least one of: a predetermined time period selected from a set of time periods and a time period determined by the first user.

9. The method of claim 1, wherein the simulated tradable assets includes at least one of: a stock, a bond, a coin affiliated with a cryptocurrency, a coin unaffiliated with a cryptocurrency, property index, a media streaming value, and a commodity.

10. A computerized method for generating simulated asset trading and gamification operations, the computerized method comprising:
engaging with a first user for determining a first wallet of virtual funds available to the first user;
accessing at least one database having simulated tradable assets stored therein, wherein the simulated tradable asset includes at least one cryptocurrency;
accessing at least one third-party pricing database having pricing information associated with the simulated tradable assets;
presenting, via the output display, at least one of a plurality of tutorials for the first user regarding electronic infrastructure associated with the simulated tradable assets, wherein the electronic infrastructure associated with the simulated tradable asset includes at least one of: an electronic wallet and a blockchain data recording operation.;
receiving selection commands from the first user for selecting at least one of the simulated tradable assets;
engaging in a competition of managing a cost of the simulated tradable assets over a defined time period, including:
calculating a buy-in cost for the first user based at least on the selection commands and the pricing information associated with the simulated tradable assets, wherein the pricing information includes a gas fee;
electronically deducting the buy-in cost from the first virtual funds;
over the defined time period, further accessing the at least one third-party pricing database and updating the pricing information associated with the simulated tradable assets;
upon further updating the pricing information, generate a costs status for the first user based on the pricing information and an ownership volume of the simulated tradable assets;
presenting, via an output display, an option for viewing at least one of a plurality of tutorials for the first user regarding simulated tradable assets, the tutorials including information regarding pricing and related information on the simulated tradable assets;
adjusting the buy-in cost accounting for simulated tradable asset infrastructure costs; and
upon completion of the defined time period, generating an output display including a final change in value of the virtual simulated tradable assets and any changes in the virtual funds.

11. The method of claim 10 further comprising:
engaging with a plurality of other users and via user interface operations receiving input commands for the plurality of other users to select a plurality of simulated tradable assets; and
via a gaming processing engine, electronically track the plurality of users versus the first user during the defined time period.

12. The method of claim 11 further comprising:
based on the gaming computing device and tracking the first user and other users profit values, upon completion of the defined time period, generating at least one tutorial for display to the first user regarding how to improve the first user's profit value during the defined time period.

13. The method of claim 10, wherein the defined time period is at least one of: a predetermined time period selected from a set of time periods and a time period determined by the first user.

14. The method of claim 10, wherein the simulated tradable assets includes at least one of: a stock, a bond, a coin affiliated with a cryptocurrency, a coin unaffiliated with a cryptocurrency, property index, a media streaming value, and a commodity.

15. A computerized method for generating simulated asset trading and gamification operations, the computerized method comprising:
determining, for each of a plurality of users, a wallet of virtual funds available for each of the plurality of users for engaging in a simulated tradable asset competition;
for each of the plurality users, receiving selection commands for selecting one or more simulated tradable assets;
accessing at least one third-party pricing database having pricing information associated with the simulated tradable assets such that the total value of the simulated tradable assets are within the virtual funds of the wallet for each user;
engaging in a competition of managing a cost of the simulated tradable assets over a defined time period, including:
calculating a buy-in cost for each of the plurality of users based at least on the selection commands and the pricing information associated with the simulated tradable assets;
electronically deducting the buy-in cost from the virtual funds;
over the defined time period, further accessing the at least one third-party pricing database and updating the pricing information associated with the simulated tradable assets;
upon further updating the pricing information, generate a costs status for each of the users based on the pricing information and an ownership volume of the simulated tradable assets;
presenting, via an output display, an option for viewing at least one of a plurality of tutorials regarding the simulated tradable assets, the tutorials including information regarding pricing and related information on the simulated tradable assets;
adjusting the buy-in cost accounting for simulated tradable asset infrastructure costs;
upon completion of the defined time period, generating an output display including a final change in value of the virtual simulated tradable assets and any changes in the virtual funds for each of the plurality of users.

16. The method of claim 15, wherein the simulated tradable asset includes a cryptocurrency.

17. The method of claim 16 further comprising:
presenting, via the output display, at least one of a plurality of tutorials regarding the electronic infrastructure associated with the simulated tradable assets.

18. The method of claim 17, wherein the electronic infrastructure associated with the simulated tradable asset includes at least one of: an electronic wallet and a blockchain data recording operation.

19. The method of claim 17, wherein the pricing information includes a gas fee.

20. The method of claim 17, wherein the simulated tradable assets includes at least one of: a stock, a bond, a coin affiliated with a cryptocurrency, a coin unaffiliated with a cryptocurrency, property index, a media streaming value, and a commodity.
